(19) United States
(12) Patent Application Publication
(10) Pub. No.: US 2003/0188955 A1
(43) Pub. Date: Oct. 9, 2003

(54) Device and method for moving books

(76) Inventor: Mario Lorenzi, Villafranca-Padova (IT)

Correspondence Address: LERNER AND GREENBERG, P.A., POST OFFICE BOX 2480, HOLLYWOOD, FL, 33022-2480, US

(21) Appl. No.: 10/408,809

(22) Filed: Apr. 7, 2003

(30) Foreign Application Priority Data
Apr. 5, 2002 (IT) PD2002A000086

(51) Int. Cl. B65G 17/12; B65G 47/34

(52) U.S. Cl. 198/468.6; 198/483.1; 270/58.07

(57) ABSTRACT

A device for moving books includes a transport device, a plurality of movable containers disposed on the transport device, a fixedly disposed container located adjacent a conveying path for the movable containers and an unloading device for transferring books previously loaded on the movable containers, to the fixedly disposed container from the movable containers. A method is also provided for cooling books for operating the book-moving device.

### BACKGROUND OF THE INVENTION

Field of the Invention

The invention relates to the field of bookbinding machines and bookbinding devices, in particular to a device and a method for moving books in or in connection with an adhesive or perfect binding device.

In the prior art, automatic devices for binding sheets have become known, which have one or more pneumatically actuatable transport tongs, for example, into which sheets to be bound are laid. The tongs convey bundles of the sheets through all of the binding stations.

Typical devices of that general type have a jogger plane which places the sheets flush with one another. Furthermore, a milling device is provided for leveling and possibly roughening all of the sheet spines. Rollers, disks or nozzles are provided for applying an adhesive to the sheet spines. A feeding device for the cover positions each cover on a cover station, with a contact pressure device for the cover, with which the latter is fixed to all of the sheets. The adhesively bound books are then trimmed on the three open sides by a trimming device.

Due to the speed at which the binding operation is carried out in such a generic device, the books reach a trimming device, which is equipped with three blades, before the adhesive has completely dried. Consequently, the trimming operations are not always able to be performed in a fault-free manner.

A device with which the trimming operation could be performed in an improved manner would, of course, be desirable, in particular wherein the drying of the adhesive has advanced further, and therefore improved trimming could be achieved.

### SUMMARY OF THE INVENTION

It is accordingly an object of the invention to provide a device and a method for moving books, which overcome the hereinafore-mentioned disadvantages of the heretofore-known devices and methods of this general type and which achieve an improvement in the trimming operation in book binding devices, based upon further advanced adhesive drying.

With the foregoing and other objects in view, there is provided, in accordance with the invention, a device for moving books, comprising a transport device, a plurality of movable containers disposed on the transport device and a fixedly disposed container located adjacent a conveying path or track for the movable containers. An unloading device is provided for transferring books, which have been previously loaded on the movable containers, to the fixedly disposed container from the movable containers.

In accordance with another feature of the invention, the transport device is disposed for performing vertical transport of the books.

In accordance with a further feature of the invention, the device for moving further includes at least one cooling device disposed along the conveying path, for at least partly cooling the books.

In accordance with an added feature of the invention, the transport device is drivable for moving the containers stepwise along the conveying path.

In accordance with an additional feature of the invention, the unloading device is disposed above the fixedly disposed container and includes a movable arm having book drivers or entrainers at an end thereof. The arm is drivable for moving the books from the fixedly disposed container to as far as an outer edge of a respective movable container.

In accordance with yet another feature of the invention, the fixedly disposed container is formed with a support plane for the books and with a vertically disposed stop edge pivotable from a vertical position into a position wherein the stop edge coincides with the support plane of the fixedly disposed container.

In accordance with yet a further feature of the invention, the fixedly disposed container is formed with a support plane for the books. The book-moving device further includes a chute disposed flush with the support plane formed by the fixedly disposed container.

In accordance with yet an added feature of the invention, the device for moving books further includes a fixedly disposed, at least approximately planar surface formed therein, and parallel longitudinal slots formed in the surface. The slots are aligned along a conveying direction of a book. Vertically disposed fingers are disposed so as to be movable in the slots. A device is provided for driving the vertically disposed fingers so that the fingers emerge from the at least approximately planar surface and are movable along the corresponding slot to as far as an opposite end of the surface, which is disposed in the vicinity of a following trimming device. The fingers are lowerable under the plane of the at least approximately planar surface and are movable back into an original position thereof.

In accordance with yet an additional feature of the invention, the device for moving books further includes a conveyor belt and two lateral guides whereon the conveyor belt is mounted. The lateral guides extend parallel to the belt and are provided above the fixedly disposed, at least approximately planar surface on a side whereat a starting movement of the vertically disposed fingers occurs. The lateral guides serve for adjusting the conveyor belt with respect to the position thereof so that coordination occurs between dimensions of the books and an operating speed of the following trimming device.

In accordance with still another feature of the invention, the transport speed of each book is coordinated with the dimensions of the book itself, with the operating speed of an accompanying processing device and with a feeding cycle rate of the respective book to the book-moving device.

In accordance with still a further feature of the invention, the book-moving device includes part of an adhesive binding device.

With the objects of the invention in view, there is also provided a method of cooling books, which comprises transferring a book from an adhesive binding station to a movably disposed container. The book is moved stepwise with the movably disposed container to a cooling device. The book is at least partly cooled with the cooling device. The book is moved stepwise with the movably disposed container to as far as an unloading device disposed above a fixedly disposed container. The book is unloaded with the unloading device, onto the fixedly disposed container.

In accordance with further modes of the invention, the foregoing method further includes at least one of the following method steps: opening an adjacent transport path by pivoting a stop of the fixedly disposed container away into an at least approximate plane aligned with the at least approximate plane of the fixedly disposed container, transporting the book diagonally along a chute, aligning the book laterally on an adjacent horizontal transport path by adjustable lateral guides, transporting the book horizontally on an adjacent horizontal transport path by vertically disposed fingers, which are disposed for movement in a surface of the horizontal transport path in parallel longitudinal slots, driving the vertically disposed fingers so that the fingers emerge from the plane and move along the corresponding slot to as far as an opposite end of the plane, which is located in the vicinity of a following trimming device, and lowering the fingers under the plane and moving them back into the original position thereof.

Accordingly, the device of the invention is a book-moving device, provided with a plurality of movable containers which are disposed on a transport device, and have a fixedly disposed container, which is provided beside a conveying path for the movable containers. An unloading device transfers the books from the movable containers to the fixedly disposed container. As a result, the transport path of the book to as far as a trimming device is advantageously lengthened, so that extended adhesive drying is achieved, and the trimming can be carried out with fewer problems. Particularly advantageously, the device according to the invention is merely inserted between the already existing transport path of a generic adhesive binding device. The movable containers are advantageously compartments which have a support surface for the books inclined with respect to the horizontal and are provided with a stop against which the books strike due to the inclined support surface. The transport device is advantageously at least one endless, paternoster-like device, to which the movable containers are fixed.

In an advantageous development of the book-moving device according to the invention, the transport device is disposed so that the transport of the books is carried out vertically. As a result, the required installation space needed by the book-moving device according to the invention is kept particularly small. As a rule, in the rooms wherein adhesive binding devices of this type are set up, there is a relatively great deal of unused space above.

In a further advantageous development of the book-moving device according to the invention, at least one cooling device is provided along the conveying section for the movable containers, and serves for at least partly cooling the books. In this regard, this is, for example, at least one electrically driven fan, advantageously a plurality of electrically driven fans. The partial cooling of the books in this case relates to partially lowering the temperature of the books, on the one hand, and of the parts of the books, in particular the book spines, to which the adhesive was applied, on the other hand. This is particularly advantageous in the case of “so-called” hot-melt adhesives, which are widespread in the field.

In a further advantageous development of the book-moving device according to the invention, the transport device is controlled so that the movable containers are moved stepwise along the conveying path. This stepwise movement advantageously meets the loading and unloading movement, respectively, of the transport device. If, moreover, cooling devices are provided on the transport device, the stepwise movement of the movable containers also affects the cooling operation. In this case, the cooling device is dimensioned so that the dwell period during the performance time of the steps of the method of the invention, which bring the books into an operative relationship with the cooling device, is just enough for cooling the books, in particular the book spines, to the desired temperature.

In a further advantageous development of the device according to the invention, the unloading device is disposed above the fixedly disposed container and includes a movable arm which has drivers or entrainers for a book at an end thereof, the arm being driven in a manner that these entrainers are movable from the fixedly disposed container to as far as the outer edge of the movable container. In an advantageous configuration of the entrainers, they are vertically disposed, downwardly directed rods, the movable arm serving to convey the rods from the fixedly disposed container to as far as the outer edge of the movable container which is disposed adjacent to the fixedly disposed container.

In a further advantageous development of the device according to the invention, the fixedly disposed container has a vertically disposed stop edge, which is pivotable from a vertical position into a position wherein the edge coincides with the support plane of the fixedly disposed container. Moreover, the fixedly disposed container is advantageously similar in geometry to the movable containers, so that it is readily possible to push the books across from the movable containers to the fixed container by the unloading device. Due to the pivoting of the stop edge, a further leading transport path can advantageously be opened. Due to an inclined support surface of the fixedly disposed container, acceleration due to gravity can advantageously serve as a drive for further transporting the books.

In a further advantageous development, the device according to the invention additionally includes a chute, which is disposed flush with the support plane of the fixedly disposed container. Here, too, acceleration due to gravity can advantageously serve for transporting a book previously moved vertically upwardly into the original processing level.

In a further advantageous development, the device according to the invention additionally has a fixedly disposed planar surface formed with parallel longitudinal slots, which are aligned along the conveying direction of a book, and vertically disposed fingers are disposed so that they are movable in these slots, and these vertically disposed fingers are driven by a device in a manner that the fingers emerge from the planar surface and move along the corresponding slot to as far as the opposite end of the plane, which is disposed in the vicinity of a following trimming device, and the fingers are lowered under the planar surface and moved back into the original position.

In a further advantageous development of the device according to the invention, a conveyor belt is mounted on two lateral guides, which run parallel to the belt and are disposed above the fixedly disposed plane on the side whereat the movement of the vertically disposed fingers is started, and the position of the aforementioned transport belt is adjustable by the aforementioned guides in a manner that coordination with the dimensions of the books and with the operating speed of the following trimming device occurs.

In a particularly advantageous development of the device according to the invention, the transport speed of each book is coordinated to the dimensions of the book itself, to the operating speed of an adjacent processing device and to the feeding cycle rate of a book to the device for moving books. In this way, the movement of the books can be adapted optimally to the specific job. The required data for determining the operating speed is advantageously determined by sensors and/or input via an operator interface and/or taken over by a higher-order control system.

Other features which are considered as characteristic for the invention are set forth in the appended claims.

Although the invention is illustrated and described herein as embodied in a device and a method for moving books, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, front-elevational view of part of the device according to the invention;

FIG. 2 is a front, side and top perspective view of FIG. 1;

FIG. 3 is a side-elevational view of a part of the device according to the invention, which adjoins the part thereof shown in FIGS. 1 and 2, and parts of a trimmer; and

FIG. 4 is a plan view of FIG. 3.

### DESCRIPTION OF THE PREFERRED EMBODIMENTS

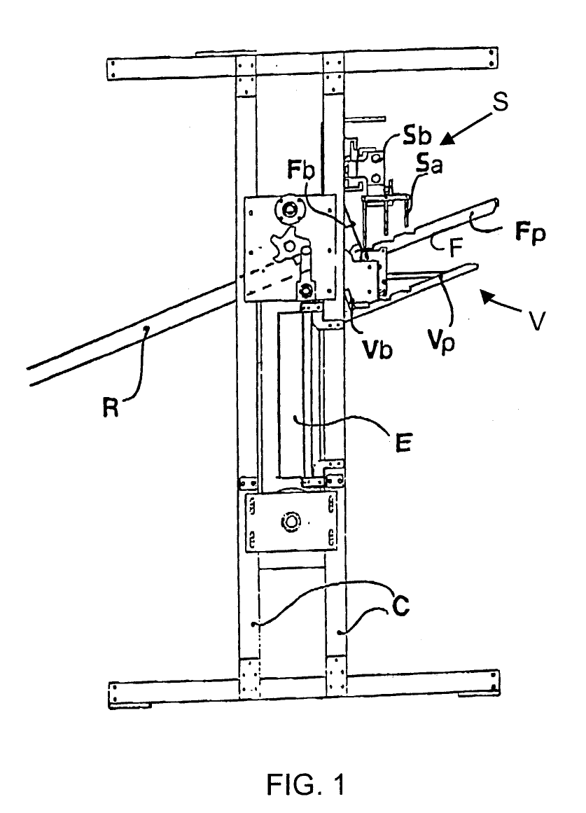

Referring now to the figures of the drawings in detail and first, particularly, to FIG. 1 thereof, there is seen a device according to the invention, also referred to hereinafter as a cooling tower, including two lateral columns C, a number of movable containers V and a fixedly disposed upper-lying container F, as well as two conveyor chains O for conveying the movable containers V in a vertical direction. The two columns C are disposed parallel to one another and have the chains O located on the inner side thereof for driving the movable containers V.

Furthermore, one or more electrically driven fans E and a discharge device S are provided.

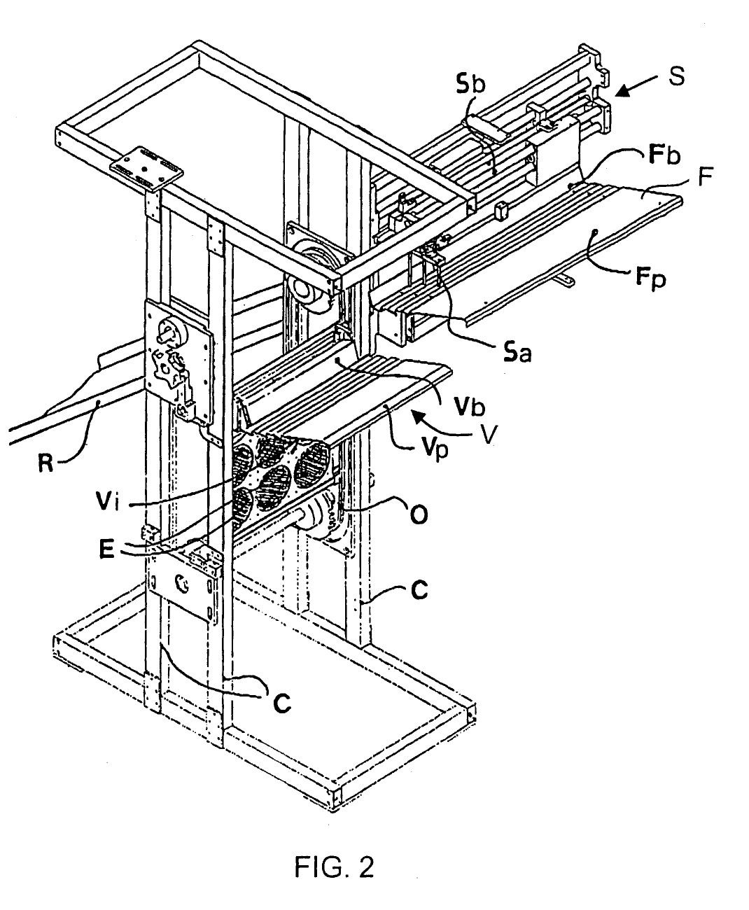

The movable containers V are generally L-shaped, i.e., they are formed with a support plane or surface Vp, which picks up and carries the book emerging from a pressing device or an adhesive or perfect binding device. In addition, the containers V have a stop edge Vb, whereon the spine of the book resting on the plane or surface Vp of the container V comes to lie. As is believed to be readily apparent from FIGS. 1 and 2, the support plane Vp is disposed inclined with respect to the horizontal, so that a book on the support plane Vp strikes the stop edge Vb due to the inclination.

The movable containers V are connected to the chains, belts or bands in such a manner that the stop edge Vb is aligned with the columns C, and in such a manner that the plane Vp of the containers V is disposed inclined. The inclination is in the direction of the stop edge Vb.

The containers V are moved upwardly by the chains O. The movement is performed stepwise and until the fixedly disposed container F has been reached. The containers V are then moved in an inverted position to the underside of the columns C along the annularly disposed strand of the chain O.

The electrically driven fans E are disposed between the columns C in the interior of the annular path of the chains O. In particular, the aforementioned electrically driven fans E are aligned in such a way that the airflow thereof is directed towards the stop edge Vb of the containers V which are moving upwardly, i.e., the airflow is directed towards the book spines.

The fixedly disposed container F has a shape and dimensions similar to those of the movable containers V. The fixedly disposed container F are disposed laterally on one of the two columns C at the highest location reachable by the movable containers V. The fixedly disposed container F is at least approximately laterally aligned with respect to the uppermost movable container V before this movable container V, which is driven by the chain O, begins the return movement thereof towards the underside of the cooling tower. The aforementioned fixedly disposed container F has, in particular, a fixedly disposed support plane or surface Fp and has a stop edge Fb, which is provided so that it can rotate and, upon demand, can be aligned flush with the support plane Fp. The transport path to the chute R is thereby opened.

Provided above the fixedly disposed container F is an unloading device S, which is advantageously formed by an arm Sb that is movable in a horizontal plane and, at the end thereof, has drivers or entrainers Sa, namely two or more vertically disposed rods Sa in the illustrated embodiment, which are downwardly directed. In particular, the movable arm Sb is aligned parallel to the stop edge Fb of the fixedly disposed container F, while the vertically disposed rods Sa are of different lengths, in order to reach to as far as the vicinity of the support plane Fp of the fixedly disposed container F. The displaceable arm Sb is mounted so that the displaceable arm Sb permits lateral displacement of the vertically disposed rods Sa to as far as the edge Vi of the movable containers V.

The connecting chute R is disposed so as to coincide with the stop edge Fb of the fixedly disposed container, and ends above an adjustable transport belt N of the stepwise driven feeding device.

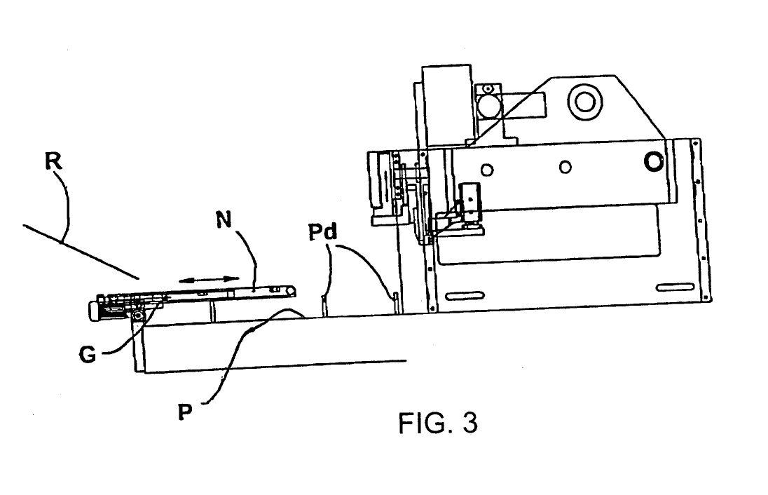

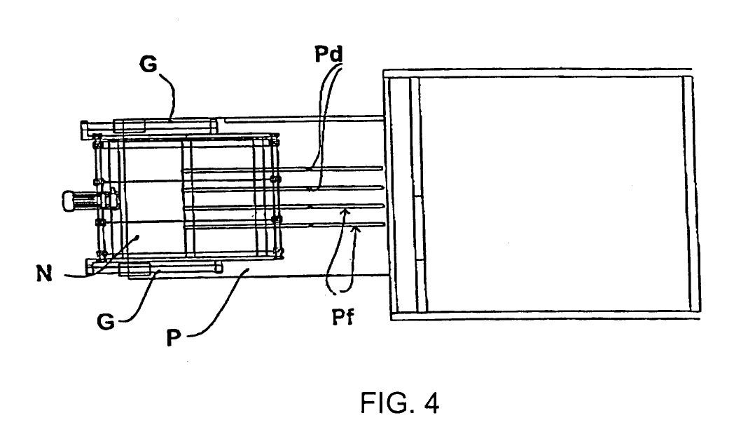

The adjacent feeding device illustrated in FIGS. 3 and 4 is driven stepwise, and has a fixedly disposed plane or surface P which is equipped with movable, vertically disposed fingers Pd, whereon an adjustable transport belt is disposed. The stationary plane or surface P has longitudinal slots Pf formed therein, which are disposed parallel to one another, and extend along the feeding direction of the book. Provided in these slots Pf are the vertically disposed fingers Pd which are movably driven by a device that lifts the fingers Pd so that they emerge from the plane P and enter into the vicinity of the transport belt N. The fingers Pd move along the corresponding slot Pf to as far as the opposite end of the plane P which is located in the vicinity of an adjacent trimming device, the fingers Pd being then lowered below the aforementioned plane P and guided back to the starting position thereof.

The transport belt N is disposed on two lateral guides G which are aligned in parallel with the belt N. The guides G permit adjustment of the position of the aforementioned belt N along the feeding direction thereof. The aforementioned transport belt N with the corresponding guides G is disposed in the plane or on the surface P and on the opposite side of the trimming devices, i.e., at the start of the movement of the vertically disposed fingers Pd.

The mode of operation of the novel transfer device for books, and the cooling operation for the book spine are summarized hereinbelow:

The book, which is formed of sheets and a cover, and which have just been bound by adhesive that has not yet cooled down, is transferred to the cooling tower. In particular, the books, respectively, reach a movable container V that is located at the bottom, the spine resting on the stop edge Vb of the container V.

The chains O move all of the movable containers V and place them in successive order in front of the electric fans E, which blow an air flow in the direction of the book spine and therefore cool this spine.

The movement caused by the chains 0 is not a continuous movement but a stepwise or step-by-step movement. Accordingly, each movable container V remains moving for a time interval which is necessary for receiving a book and for making it possible for the book to be exposed to the air flow from the electrically driven fans E for the required time so as to effect the desired, in particular complete, cooling of the adhesive which has been applied to the spine of the book and the cover. In an alternative embodiment, the adhesive is not cooled completely but only to such an extent that the adhesive cools down completely in the following transport section yet to be passed through. As a result, a given acceleration of the transport of the books along the transport section can be achieved, which increases the output of the adhesive binder.

The instant the appropriately moved container V with the book reaches the position of the fixedly disposed container F, the book is transferred by the discharge device from the moving container V to the fixedly disposed container F. The instant the movable container V reaches the fixedly disposed container F, the movable arm Sb of the unloading device performs a displacement of the vertically disposed rods Sa which are disposed at the end of the arm Sb to as far as the edge Vi of the movable container V which is located opposite the fixedly disposed container F. The corresponding movable container V then reaches the fixedly disposed container F and is aligned opposite to the latter, and the movable arm Sb moves back and, by the vertically disposed rods Sa thereof, displaces the book from the movable container V to the fixedly disposed container F. The movable container V, which is conveyed by the chain O, then moves into the return path thereof and moves downwardly to as far as the base of the cooling tower in order to pick up a new book thereat.

The fixedly disposed container F, after the latter has received a book, pivots the stop edge Fb thereof into a position aligning with the support plane Fp, and transfers the corresponding book to the connecting chute R in order then to lift the stop edge Fb for receiving a further book.

The book which is in downward movement on the connecting chute R reaches the transport belt N of an adjacent feeding device, which is driven stepwise and discharges the book to the plane or surface P. This transport belt N is disposed along the guide G in such a way that the feeding movement of each book is coordinated with the dimensions of the book itself, to the operating speed of the trimming device and to the feeding cycle rate of a book to the cooling tower. The book placed on the transport belt N of the plane E is fed to the trimming device by the vertically disposed fingers Pd.

It is believed that the foregoing are sufficient descriptions of diagrammatically illustrated operations for permitting those skilled in the art to implement the invention.

I claim:

1. A device for moving books, comprising:
a transport device;
a plurality of movable containers disposed on said transport device;
a fixedly disposed container located adjacent a conveying path for said movable containers; and
an unloading device for transferring books, previously loaded on said movable containers, to said fixedly disposed container from said movable containers.

2. The device for moving books according to claim 1, wherein said transport device perfors vertical transport of the books.

3. The device for moving books according to claim 1, further comprising at least one cooling device disposed along said conveying path, for at least partly cooling the books.

4. The device for moving books according to claim 1, wherein said transport device is to be driven for moving said containers stepwise along said conveying path.

5. The device for moving books according to claim 1, wherein said unloading device is disposed above said fixedly disposed container and includes a movable arm having book drivers at an end thereof, and said arm is driven for moving the books from said fixedly disposed container to as far as an outer edge of a respective one of said movable containers.

6. The device for moving books according to claim 1, wherein said fixedly disposed container defines a support plane for the books and a vertically disposed stop edge pivotable from a vertical position into a position wherein said stop edge coincides with said support plane defined by said fixedly disposed container.

7. The device for moving books according to claim 1, wherein said fixedly disposed container defines a support plane for the books, and the book-moving device includes a chute disposed flush with said support plane defined by said fixedly disposed container.

8. The device for moving books according to claim 1, further comprising:
a fixedly disposed, at least approximately planar surface having parallel longitudinal slots formed therein, said slots being aligned along a conveying direction of a book;
vertically disposed fingers to be moved in said slots; and
a device for driving said vertically disposed fingers causing said fingers to emerge from said at least approximately planar surface and be movable along a corresponding one of said slots to as far as an opposite end of said surface, disposed in vicinity of a following trimming device, said fingers to be lowered under the plane of said at least approximately planar surface and being movable back into an original position thereof.

9. The device for moving books according to claim 8, further comprising:
a conveyor belt;
two lateral guides;
said conveyor belt mounted on said lateral guides, said lateral guides extended parallel to said belt and disposed above said fixedly disposed, at least approximately planar surface on a side, a starting movement of said vertically disposed fingers occurring at said side, said lateral guides serving for adjusting said conveyor belt with respect to a position thereof causing coordination to occur between dimensions of the books and an operating speed of the following trimming device.

10. The device for moving books according to claim 1, wherein a transport speed of each book is coordinated with dimensions of the book itself, with an operating speed of an accompanying processing device and with a feeding cycle rate of the respective book to the book-moving device.

11. An adhesive binding device, comprising a book-moving device according to claim 1.

12. A method of cooling books, which comprises:
transferring a book from an adhesive binding station to a movably disposed container;
stepwise moving the book with the movably disposed container to a cooling device;
at least partly cooling the book with the cooling device;
stepwise moving the book with the movably disposed container to as far as an unloading device disposed above a fixedly disposed container; and
unloading the book, with the unloading device, onto the fixedly disposed container.

13. The method according to claim 12, which further comprises at least one of the following method steps:
opening an adjacent transport path by pivoting away a stop of the fixedly disposed container into an at least approximate plane aligned with an at least approximate plane of the fixedly disposed container;
transporting the book diagonally along a chute;
aligning the book laterally on an adjacent horizontal transport path by adjustable lateral guides;
transporting the book horizontally on an adjacent horizontal transport path with vertically disposed fingers disposed for movement in a surface of the horizontal transport path in parallel longitudinal slots;
driving the vertically disposed fingers causing the fingers to emerge from the plane and move along the corresponding slot to as far as an opposite end of the plane located in vicinity of a following trimming device, and lowering the fingers under the plane and moving the fingers back into the original position thereof.
